(19) United States
(12) Patent Application Publication
(10) Pub. No.: US 2012/0123566 A1
(43) Pub. Date: May 17, 2012

(54) SYSTEMS AND METHODS FOR RECORDING AND DISPLAYING GAMING METRICS FOR PLAYERS AND PRODUCTS INCORPORATING THE SAME

(76) Inventor: Aamon Cade Ross, Tulsa, OK (US)

(21) Appl. No.: 13/290,214

(22) Filed: Nov. 7, 2011

Related U.S. Application Data
(60) Provisional application No. 61/410,409, filed on Nov. 5, 2010.

(51) Int. Cl. G06F 19/00

(52) U.S. Cl. 700/91

(57) ABSTRACT

Systems and methods for recording and displaying gaming metrics for poker players are provided herein. According to some embodiments, the methods may include receiving, via a gaming server, a signal that a felting event has occurred, the felting event including a first player successfully winning an all in bet against at least one additional player during a hand of poker, storing information indicative of the felting event in a player record, and providing the information indicative of the felting event to the client device.

### CROSS-REFERENCE TO RELATED APPLICATION(S)

This nonprovisional patent application claims the benefit of provisional U.S. Patent Application Ser. No. 61/410,409, filed on Nov. 5, 2010, entitled “SYSTEMS AND METHODS FOR RECORDING AND DISPLAYING GAMING METRICS FOR PLAYERS AND PRODUCTS INCORPORATING THE SAME”—which is hereby incorporated by reference in its entirety.

### BACKGROUND OF THE INVENTION

1. Field of the Invention

The present invention relates in general to systems and methods for recording and displaying gaming metrics, and more particularly, but not by way of limitation, to systems and methods for recording and displaying various poker gaming metrics. In some embodiments, the present invention is directed to physical and digital embodiments of a product for recording and displaying gaming metrics corresponding to particular players that may be obtained by opposing players during game play.

2. Background Art

While games such as poker are extremely competitive and are the subject of various types of statistical analysis corresponding to game play, various metrics relative to the outcomes of such games currently remain unevaluated. For example, many statistics may be collected and analyzed during game play to determine the relative strength of a player's cards in relation to other players' cards or the house (e.g., dealer). These statistics may be expressed as percentages and may be utilized to predict potential outcomes of a hand. Commonly utilized variables for calculating percentages are number of players participating in the hand, the current strength of a player's cards, and the availability of additional cards that can affect the outcome of the hand—just to name a few.

While these currently known methods generate statistics during game play, Applicant is unaware of any systems or methods for recording the outcomes of game play on a player specific level, such as number of hands won and/or lost, names of opposing players relative to the number of hands won and/or lost, the amount of money won and/or lost within a predetermined amount of time, and the number of times a player has defeated another player during a game where both players have gone “all in” such as when all players participating in a particular round have bet all of their available poker chips. Additionally, Applicant is unaware of any products that denote when a player has won or lost an “all in” hand during game play, or any methods for exchanging rewarding prizes based upon the collection of such products from opposing players.

It is therefore an object of the present invention, among others, to provide systems and methods for recording and displaying gaming metrics, and in some embodiments, systems and methods for recording and displaying various poker gaming metrics. According to some embodiments, the present invention is directed to physical and digital embodiments of a product for recording and displaying gaming metrics corresponding to particular players, and methods for rewarding prizes based upon collecting such products from opposing players.

In some additional embodiments, the present invention is directed to systems and methods for placing a side bet within a poker game or series of poker games based upon the exchange of one or more products such as markers bearing one or more gaming metrics.

These and other objects of the present invention will become apparent in light of the present specification, claims, and drawings.

### SUMMARY OF THE INVENTION

According to some embodiments, the present technology may be directed to methods for recording and displaying gaming metrics for poker players. The methods may include: (a) receiving, via a gaming server, a signal that a felting event has occurred, the felting event including a first player successfully winning an all in bet against at least one additional player during a hand of poker; (b) storing information indicative of the felting event in a player record; and (c) providing the information indicative of the felting event to the client device.

According to other embodiments, the present technology may be directed to methods for providing a reward during a poker tournament. The method may include: (a) ranking poker players according to an aggregate number of felting events acquired by each poker player, the felting event including a first player successfully winning an all in bet against at least one additional player during a hand of poker; and (b) providing a reward to at least one poker player based upon their ranking.

According to additional embodiments, the present technology may be directed to systems for generating player metrics. The systems may include: (a) a memory for storing executable instructions; (b) a processor for executing the instructions, the instructions comprising: (i) an analysis module that receiving, via a gaming server, a signal that a felting event has occurred, the felting event including a first player successfully winning an all in bet against at least one additional player during a hand of poker; (ii) a database module that stores information indicative of the felting event in a player record; and (iii) a user interface module for providing the information indicative of the felting event to the client device.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be understood that the invention is not necessarily limited to the particular embodiments illustrated herein.

FIG. 1 is an exemplary environment for practicing one or more embodiments of the present invention;

FIG. 2 is a block diagram of a metrics application for use in accordance with some embodiments of the present invention;

FIG. 3 is a front elevational view of a marker having a plurality of indicia that represent one or more player metrics; and

FIG. 4 is a block diagram of an exemplary computing system for executing one or more functions of a method for recording and displaying gaming metrics, in accordance with various embodiments of the present invention.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

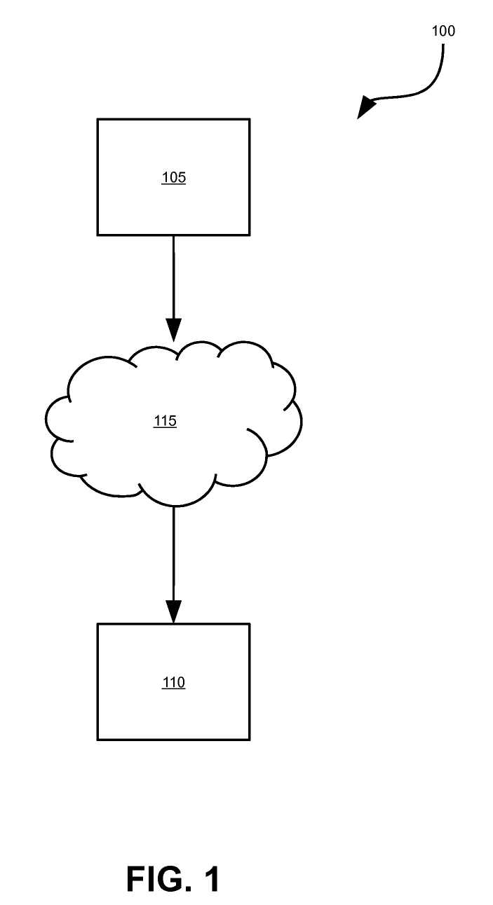

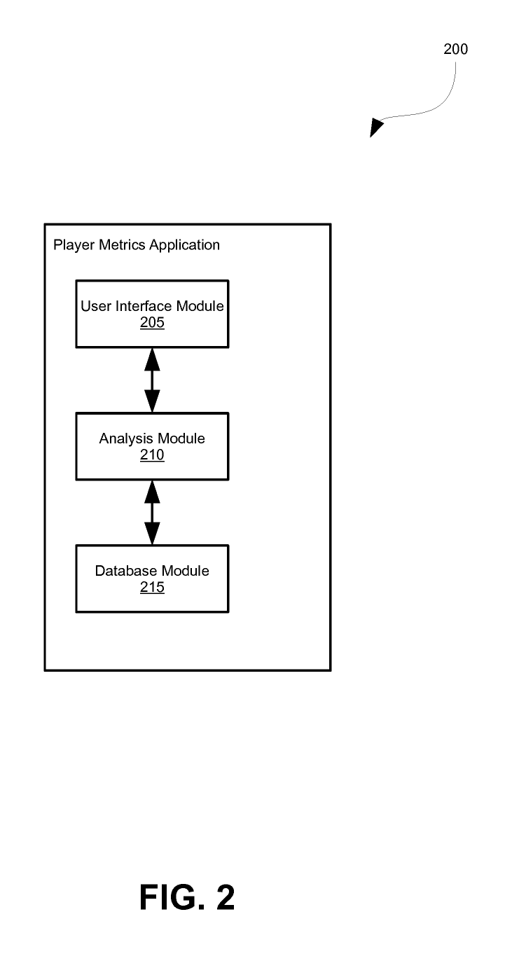

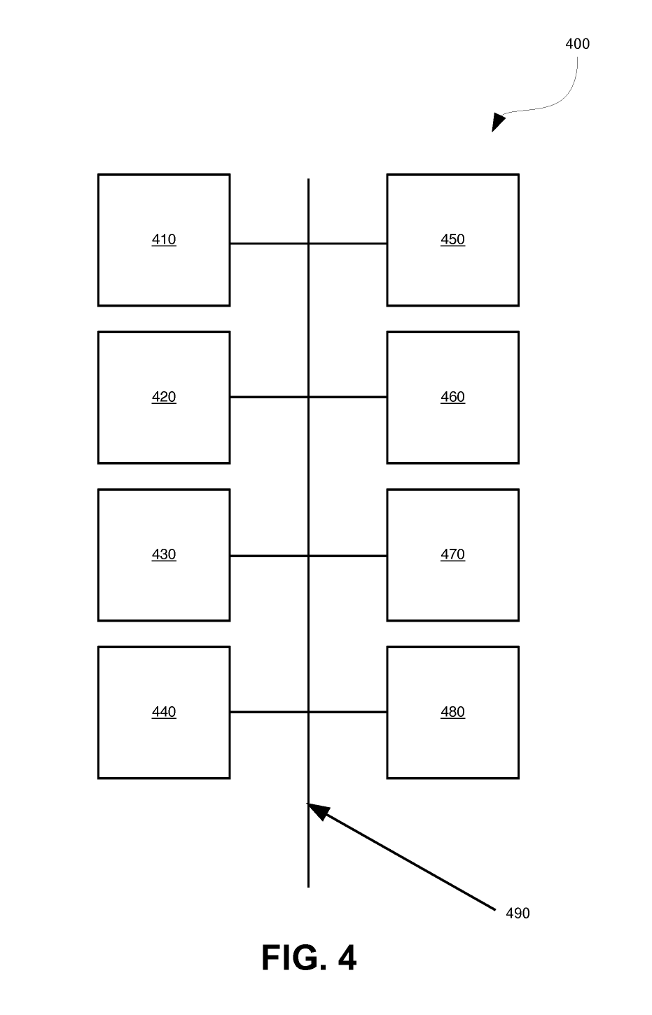

Referring now to the drawings and more particularly, to FIGS. 1-4 collectively, exemplary architecture 100 that may be utilized to implement embodiments of the present invention is shown. According to some embodiments, architecture 100 includes one or more client devices 105, such as a computing system, which is described in greater with regards to computing system 400 as shown in FIG. 4. Each client device 105 is operatively connected to gaming server(s) 110 via network 115. It will be understood that network 115 may include any number of communication mediums such as LAN (Local Area Network), WAN (Wide Area Network), the Internet, a VPN (Virtual Private Network) tunnel, or combinations thereof.

Player metrics application 200 may reside on gaming server 110, although it will be understood that all or a portion of player metrics application 200 may reside locally on client device 105. Generally speaking, player metrics application 200 may include user interface module 205, analysis module 210, and database module 215. It is noteworthy that player metrics application 200 may be composed of more or fewer modules and engines (or combinations of the same) and still fall within the scope of the present technology. Additionally, it will be understood that the constituent modules described herein may be executed by a processor of a computing system to effectuate respective functionalities attributed thereto.

It will be understood that player metrics application 200 may be included as a constituent module of a gaming application (not shown) that resides on at least one of client device 105 and gaming server(s) 110. Gaming applications are well known in the art and it would be well within the level of one of ordinary skill the art to incorporate the features of player metrics application 200 within such gaming applications. For the sake of brevity, a detailed discussion of the entire process for incorporating the features of player metrics application 200 within a gaming application will not be included.

Generally speaking, user interface module 205 is adapted to generate one or more user interfaces that allow end users to interact with player metrics application 200. Although not shown, one exemplary user interface may be adapted receive information indicative of an end user, also known as a player, for establishing a user profile that may reside on a database associated with at least one of client device 105 or gaming server(s) 110. In some embodiments, the user interface may include a plurality of input devices adapted to receive input indicative of, for example, a username, a password, and one or more player metrics (e.g., statistics, rewards, age, year of experience, quotations, etc.)—just to name a few. It will be understood that the term “player metrics” as used herein may include data indicative of various outcomes of game play and/or the exchange of particular products during game play such as markers, the creation and utilization of which will be discussed in greater detail herein.

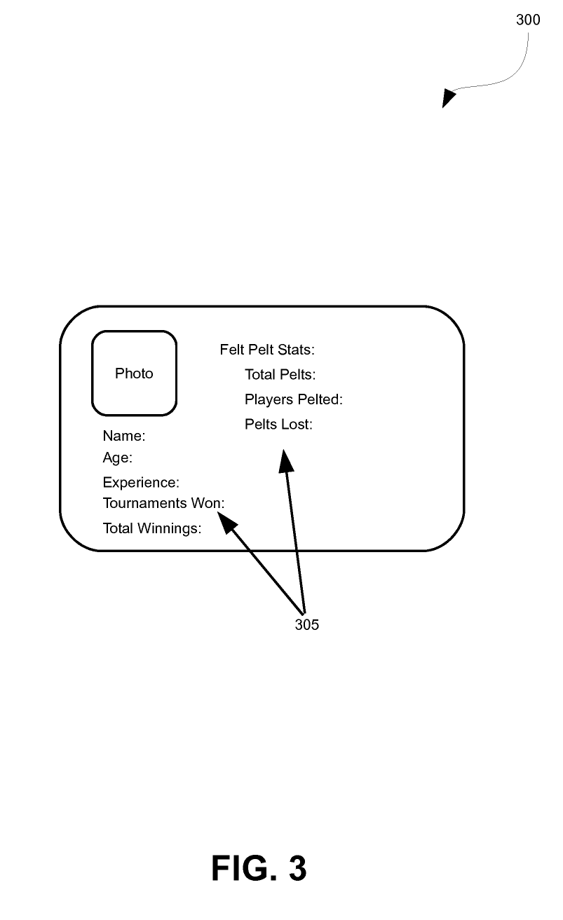

Analysis module 210 may be adapted to receive information indicative of various player metrics relative to the outcome of hands from, for example, a gaming application, or may be input by an end user independent from the gaming application. Non-limiting examples of player metrics may include particular outcomes relative to what is commonly known as “going all in” wherein at least one of two or more players have bet all of their poker chips on one hand. For example, if a first player “pushes” a second player “all in,” and the second player being pushed “all in” loses the game, the second player is eliminated from the table. The act of being eliminated may be commonly referred to as being “felted,” also known as a “felting event.” In this instance, analysis module 210 receives input indicative of the elimination of the second player and causes database module 215 to create an entry in a user record for the second player that may reside on a database. It will be understood that the analysis module 210 may generate a pelt, which is similar to a virtual token that may be provided to the winning player, upon being “felted.” An exemplary pelt (e.g., marker 300) is illustrated and described in greater detail relative to FIG. 3. It will be understood that the pelt may include both virtual and physical embodiments of a pelt. Database module 215 may also create an entry in the user record of the first player indicative of the elimination or felting, such as the name of the losing player, a date, or other corresponding information such a pot size, time of day, player ranking, and so forth. These user records/virtual markers may be cross-linked to a previously established user profile corresponding to the particular player. It will further be understood that these player metrics may be stored directly as entries in the user profile.

With regards to tournament style gaming, a player may have an opportunity to eliminate a plurality of opposing players during the tournament. As such, the player may receive multiple “pelts” during the tournament. Therefore, analysis module 210 may be adapted to analyze the user records and/or user profiles for each player participating in the tournament and output metric data indicative of the number of “pelts” obtained by each player within the tournament. In some embodiments, analysis module 210 may cause user interface module 205 to generate and display a user interface that includes player metric data indicative of the number of “pelts” obtained by each player within the tournament. These player metrics may be utilized as the basis for rewarding prizes to tournament players, or may be displayed as player metrics that are accessible to the player, the player's opponents, or other entities.

Additionally, methods for establishing side bets based upon the anticipated numbers of “pelts” traded within a given tournament or within a particular amount of hands are provided herein. For example, in tournament gaming, a prize may be established for the player who obtains the greatest number of “pelts” within the tournament. In an additional example, individual players may place a side bet that predicts first player to lose their “pelt.” Side bets may be placed with the house. As such, the house may be required to provide a payout to a player that places a successful side bet.

It will be understood that the side bets described above may be appropriate in both tournament and non-tournament gaming. It will also be understood that the side bets as described above may be implemented electronically with respect to online gaming as well as physically with respect to gaming in casinos or other establishments.

In physical embodiments, each player or a group of players may be provided with a marker 300 that may include indicia 305 indicative of statistics or player metrics relative to the player. In some embodiments, the indicia 305 may include data contained within the user profile and user records associated with the player such as an aggregate number of “pelts” obtained by the player, the name of the opponent the player took the “pelt” from, and the like. It will be understood that the player may be provided with a new marker 300 for each game in which the player is participating that may include updated player metrics relative to a previous tournament or game play. In some embodiments, such as non-tournament play, marker 300 may include a print out that includes indicia 305. In tournament play, marker 300 may include, for example, a token, a plaque, or number of products having a variety of structural, ornamental, or functional features. In some embodiments, marker 300 may be generated by user interface module 205 and displayed on the client device 105.

According to some embodiments, the present invention is directed to a marker 300 produced by the process of recording various player metrics indicative of game play according to one or more of the above-described methods and utilizing the recorded player metrics as indicia that may be applied to a first or second surface of marker 300. Markers 300 may be updated and reproduced at predetermined intervals such that the indicia include temporally relevant player metrics.

Although not shown, in some embodiments, the present invention may be utilized as a portion of the basis for ranking players. For example, players may be divided into ranks such as platinum, gold, and silver, based upon the aggregate number of markers received at a tournament or within a particular time frame (e.g., group of tournaments).

FIG. 4 illustrates an exemplary computing system 400 that may be used to implement various portions of the present invention. Computing system 400 of FIG. 4 may be implemented in the context of client devices 105, gaming server(s) 110, and the like. The computing system 400 of FIG. 4 includes one or more processors 410 and memory 420. Main memory 420 stores, in part, instructions and data for execution by processor 410. Main memory 420 can store the executable code when computing system 400 is in operation. Computing system 400 of FIG. 4 may further include mass storage device 430, portable storage medium drive(s) 440, output devices 450, user input devices 460, graphics display 470, and other peripheral devices 480.

The components shown in FIG. 4 are depicted as being connected via single bus 490. The components may be connected through one or more data transport means. Processor unit 410 and main memory 420 may be connected via a local microprocessor bus, and mass storage device 430, peripheral device(s) 480, portable storage medium drive 440, and graphics display 470 may be connected via one or more input/output (I/O) buses.

Mass storage device 430, which may be implemented with a magnetic disk drive or an optical disk drive, is a non-volatile storage device for storing data and instructions for use by processor 410. Mass storage device 430 can store the system software for implementing embodiments of the present invention for purposes of loading that software into main memory 420.

Portable storage medium drive 440 operates in conjunction with a portable non-volatile storage medium, such as a floppy disk, compact disk or Digital video disc, to input and output data and code to and from computing system 400 of FIG. 4. The system software for implementing embodiments of the present invention may be stored on such a portable medium and input into computing system 400 via portable storage medium drive 440.

Use input devices 460 provide a portion of a user interface. User input devices 460 may include an alphanumeric keypad, such as a keyboard, for inputting alphanumeric and other information, or a pointing device, such as a mouse, a trackball, stylus, or cursor direction keys. Additionally, computing system 400 as shown in FIG. 4 includes output devices 450. Suitable output devices include speakers, printers, network interfaces, and monitors.

Graphics display 470 may include a liquid crystal display (LCD) or other suitable display device. Graphics display 470 receives textual and graphical information, and processes the information for output to the display device.

Peripheral devices 480 may include any type of computer support device to add additional functionality to the computer system. Peripheral device(s) 480 may include a modem or a router.

The components contained in computing system 400 of FIG. 4 are those typically found in computer systems that may be suitable for use with embodiments of the present invention and are intended to represent a broad category of such computer components that are well known in the art. Thus, computing system 400 of FIG. 4 can be a personal computer, hand held computing system, mobile gaming devices, telephone, automated bank teller machine (ATM), mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, iOs, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Methods for recording and displaying gaming metrics for poker players may include a step of receiving, via a gaming server, a signal that a felting event has occurred, the felting event including a first player successfully winning an all in bet against at least one additional player during a hand of poker. Next, the method may include a step of storing information indicative of the felting event in a player record. Additionally, the method may include a step of providing the information indicative of the felting event to the client device. Optional steps may include, for example, generating a virtual reward for the felting event, storing the virtual reward in a database, along with providing the virtual reward to the first player.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

1. A method for recording and displaying gaming metrics for poker players, the method comprising:
receiving, via a gaming server, a signal that a felting event has occurred, the felting event including a first player successfully winning an all in bet against at least one additional player during a hand of poker;
storing information indicative of the felting event in a player record; and
providing the information indicative of the felting event to a client device.

2. The method according to claim 1, further comprising:
generating a virtual reward for the felting event;
storing the virtual reward in a database; and
providing the virtual reward to the first player.

3. The method according to claim 1, further comprising:
determining a player with a greatest number felting events within a given number of hands of poker; and
providing a reward to the first player.

4. The method according to claim 1, further comprising ranking a plurality of poker players according to number of virtual rewards obtained.

5. The method according to claim 1, wherein the reward includes a virtual reward comprising information indicative of an aggregate number of felting events won by the first player.

6. The method according to claim 5, wherein the virtual reward further includes indicia for a name for each felting event, the name representing a poker player that was defeated by the first player.

7. A method for providing a reward during a poker tournament, the method comprising:
ranking poker players according to an aggregate number of felting events won by each poker player, the felting event including a first player successfully winning an all in bet against at least one additional player during a hand of poker; and
providing a reward to one or more poker players based upon their ranking.

8. The method according to claim 7, wherein the reward includes at least one of a virtual reward and a physical reward.

9. The method according to claim 8, wherein the virtual reward includes a virtual marker that includes information that represents a poker player that lost the felting event to the first player.

10. The method according to claim 7, further comprising providing a plurality of virtual rewards to the first player, wherein the plurality of virtual rewards includes each of the virtual rewards obtained by the at least one additional player during the poker tournament.

11. The method according to claim 7, wherein the reward includes a marker that includes a body with indicia, wherein the indicia includes any of a photograph, a player name, statistics relative to the first player, statistics relative to poker players that the first player has successfully defeated in a felting event, an aggregate amount of monetary winnings for the first player, an aggregate number of poker tournaments won by the first player, and combinations thereof.

12. The method according to claim 7, further comprising establishing a side bet during a hand of poker, the side bet specifying a successful poker player involved in a felting event, and providing a payout to a player that places the side bet.

13. The method according to claim 7, further comprising establishing a side bet during a hand of poker, the side bet specifying a first poker player to lose a felting event.

14. The method according to claim 7, further comprising establishing a side bet during a hand of poker, the side bet based upon an anticipated number of pelts traded within at least one of: (a) a given poker tournament and (a) a particular amount of hands of poker.

15. A system for generating player metrics, the system comprising:
a memory for storing executable instructions;
a processor for executing the instructions, the instructions comprising:
an analysis module that receiving, via a gaming server, a signal that a felting event has occurred, the felting event including a first player successfully winning an all in bet against at least one additional player during a hand of poker;
a database module that stores information indicative of the felting event in a player record; and
a user interface module for providing the information indicative of the felting event to a client device.

16. The system according to claim 15, wherein the user interface module further:
generates a virtual reward for the felting event;
stores the virtual reward in a database; and
provides the virtual reward to the first player.

17. The system according to claim 15, wherein the analysis module further:
determines a player with a greatest number felting event within a given number of hands of poker; and
provides a reward to the player.

18. The system according to claim 15, wherein the analysis module further ranks a plurality of poker players according to number of virtual rewards obtained.

19. The system according to claim 16, wherein the reward include a virtual reward comprising information indicative of an aggregate number of felting events for the player.

20. The system according to claim 19, wherein the virtual reward further includes a name for each felting event, the name representing a poker player that was defeated by the player.
